(19) United States
(12) Patent Application Publication
(10) Pub. No.: US 2007/0221543 A1
(43) Pub. Date: Sep. 27, 2007

(54) Particle Separating Device

(75) Inventors: Timo Karmeniemi, Helsinki (FI); Jukka Tuunanen, Helsinki (FI)

Correspondence Address: NIXON & VANDERHYE, PC, 901 NORTH GLEBE ROAD, 11TH FLOOR, ARLINGTON, VA, 22203, US

(73) Assignee: THERMO ELECTRON OY, Vantaa (FI)

(21) Appl. No.: 10/578,861

(22) PCT Filed: Nov. 9, 2004
(86) PCT No.: PCT/FI04/00658

§ 371 Date: Apr. 10, 2007

(30) Foreign Application Priority Data
Nov. 11, 2003 (FI) 20031635

(51) Int. Cl. B03C 1/00

(52) U.S. Cl. 209/223.1

(57) ABSTRACT

The invention relates to a device (2) for separating magnetic particles comprising several substantially aligned magnets (3). Some of the magnets (3) are inversely oriented. This array reduces any magnetic interference with the collection area of an adjacent magnet.

### FIELD OF TECHNOLOGY

The invention relates to techniques for separating magnetic particles and is directed to a device used in the separation. The invention is applicable to various chemical methods for separating particles from liquid mixtures containing them.

### BACKGROUND OF TECHNOLOGY

Magnetic particles are employed in various methods as a solid phase on whose surface a reaction is allowed to occur. A particle is typically coated with a substance having a specific reaction with a given second substance. This allows separation of this second substance from a mixture in which it is contained.

The particles usually need to be separated from the reaction mixture after the reaction. This has been conventionally done by removing the reaction medium from the vessel and by leaving the particles in the vessel.

WO 94/18565 discloses a method and a device for separating particles by removing them from a vessel. This is done with the aid of an elongated remover comprising a magnet located within a casing and movable in it in the longitudinal direction. As the remover is introduced into a mixture with the magnet in lower position, the particles adhere to the surface of the remover and can thus be removed from the mixture. By contrast, as the magnet is pulled into upper position, the particles are detached from the surface of the remover. The device may comprise a plurality of removers operating in parallel so as to allow simultaneous treatment of a plurality of samples. WO 96/12958 discloses a similar remover, whose magnet has a length such that only the lower pole of the magnet collects particles. Such separating techniques have also been commercially implemented in the KingFisher® separating devices of Thermo Electron Oy, Finland. These devices comprise a plurality of removers disposed in parallel, with their magnets oriented in the same direction, i.e. with similar poles always oriented in the same direction.

### SUMMARY OF THE INVENTION

A separating device as defined in claim 1 has now been invented. The other claims define some embodiments of the invention.

In accordance with the invention, the separating device comprises a plurality of substantially aligned magnets in parallel. Some of the magnets are oriented in the opposite direction. This array reduces the effect of the magnets on the separation areas of adjacent magnets.

The greater the number of magnets included in the separating device, the more useful the invention.

### DRAWINGS

The accompanying drawings pertain to the written description of the invention and relate to the detailed description of the invention given below. In the drawings,

FIG. 1 shows a separating apparatus of the invention

FIG. 2 shows the separating device of the separating apparatus and separately the comb of casings and sample plate used with the separating device

FIG. 3 is a cross-sectional view of the separating device, comb of casings and sample plate in nested arrangement

FIGS. 4-9 illustrate various manners of positioning the magnets in opposite directions.

### DETAILED DESCRIPTION OF THE INVENTION

The separating device of the invention comprises a plurality of aligned magnets substantially in parallel, a number of which are oriented in the opposite direction, in other words, with the north pole of at least one magnet directed upwardly and the north pole of at least another directed downwardly. Thus, for instance, about half of the magnets may be inversely oriented, especially with every second magnet oriented in the opposite direction. The magnets may particularly be placed in a matrix array comprising a plurality of magnet rows. This allows the magnets to be positioned e.g. with the magnets of an entire row, especially a shorter row in the case of a matrix not shaped as a square, all oriented in the same direction. Developments of various different combinations are also conceivable.

The invention provides the benefit of the magnets interfering less with particle collection from the collecting areas of adjacent magnets. In particular, it reduces particle adhesion to the side walls of the separating vessel. In fact, the inventors have found that, because the fields formed of equally oriented magnets reject each other, the fields of the magnets in the border zone are slightly tilted towards the border areas of the magnet matrix due to the rejecting effect of the magnets in the central area. Inclined magnetic field beams tend to act also on the neighbouring vessel, thus binding part of the particles of the adjacent vessel to the vessel walls. These particles are at risk of not being collected by the magnet specific to this vessel, and there will thus remain uncollected particles in the well. With the magnets positioned in the opposite direction in accordance with the invention, the magnetic fields will be fixed between the magnets. With the magnetic fields locally fixed, the magnets will not generate a far-reaching rejecting effect, and the collection will be locally defined to the vessel located at the magnet.

The invention also provides other, partly quite different advantages. Firstly, the effect of external disturbing factors will decrease. Magnetic materials outside the magnet matrix (tracks, motors, box structures) tend to act on the inclination of the field beams generated by the magnets. The field of magnets oriented in the opposite direction will be fixed between the magnets, resulting in a decrease of such interference. Secondly, a weaker magnetic field will now act outside the separating device. This reduces any interference with other apparatus. This also facilitates protection during transport. Air transportation, for instance, is subject to specific upper limits for the magnetic field generated by the freight. Magnetic fields might also cause interference with for instance therapeutic devices such as pacemakers. Thirdly, magnets will be bent to a lesser extent under the action of attractive forces of the free poles of adjacent magnets with alternating pole directions than they are under the action of repulsive forces of like poles.

Magnets are usually united into one single piece, called a magnet head. The magnet head may be disposed vertically movable in a separating device.

Each magnet head may have a casing in which it is movable. The casings are also usually joined to form one single piece disposed in the device so as to be vertically movable under the magnet head.

The magnets may especially be elongated so as to allow particle collection on the tip of the separator (cf. WO 96/12959). The ratio of the length to the thickness of the magnet may be e.g. at least about 2:1, such as at least 5:1. During particle collection, the upper pole of the magnet is preferably kept above the mixture. However, conventional short magnets are also applicable. The separator tip is preferably pointed and convex (cf. WO 94/18564, WO 94/18565 and WO 96/12959). An agent for reducing surface tension may be dosed into the mixture containing the particles, thus enhancing particle adhesion to the separator (cf. WO 00/42432).

The magnet particles to be separated may be micro particles in particular. The maximum particle size is e.g. 50 μm, such as 10 μm. The minimum size may be e.g. 0.05 μm. The typical particle size is in the range 0.5-10 μm.

Particles are usually coated with a substance having specific reaction with a component in the sample.

Some embodiments of the invention are further disclosed in detail below.

The separating apparatus 1 is used for treating samples in micro filtration plate format comprising 8*12 wells with a 9 mm distribution.

The apparatus has a magnet head 2 comprising 96 elongated permanent magnets 3 (length/thickness about 10:1) with the same distribution as the plate, the upper ends of the permanent magnets being joined by means of a support plate. The magnets are preferably made of a material (e.g. NeFeB) that has high remanence and coercivity. The magnet head is fixed to a lifting device 4, which is movable in the vertical direction. At the same location under the magnet head a casing support 5 is provided, which has a hole at the location of each magnet. The casing support is fixed to a lifting device 6 so as to be movable in the vertical direction. A comb of casings 7 is disposed on the casing support, this comb comprising a casing 8 for insertion of each magnet. At its lower end, the casing has a separating area shaped as a cone with a concave surface, with a sharp lower tip at the centre.

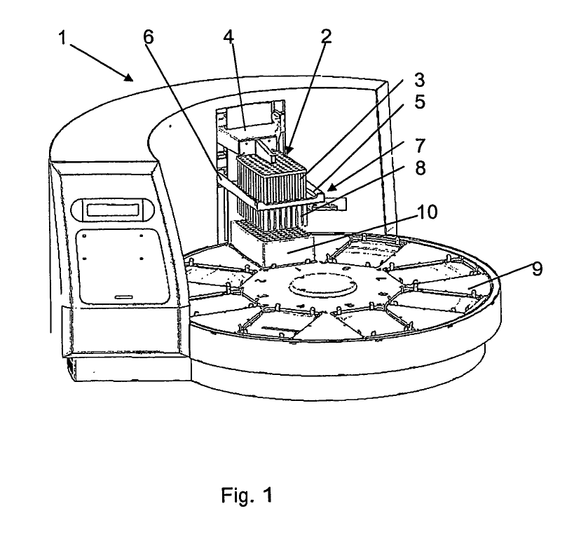

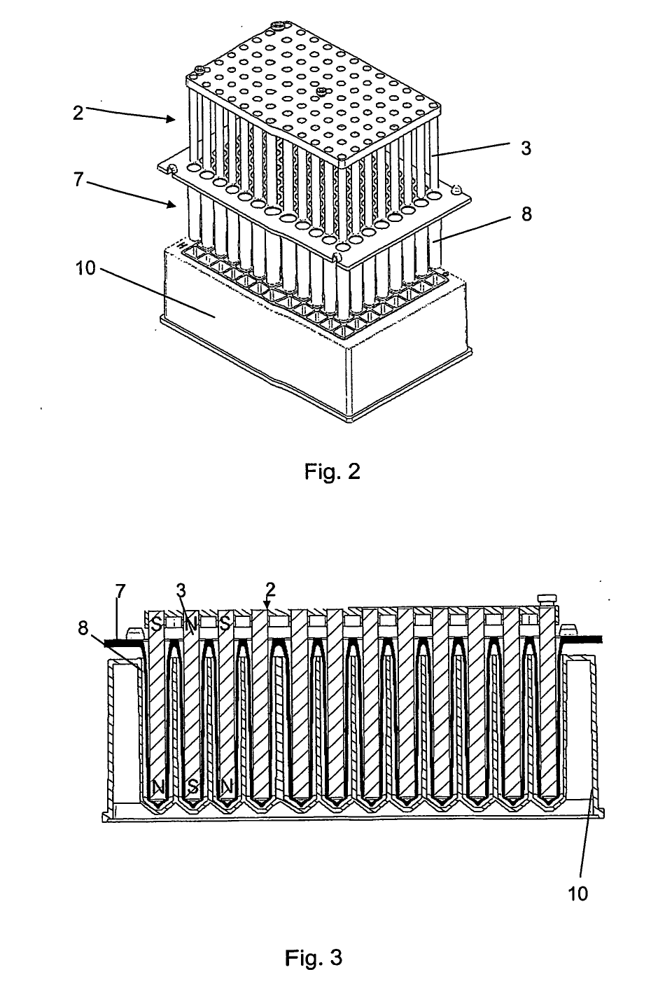

The apparatus comprises a rotating tray 9 with locations for sample plates 8. By rotating the tray, the desired plate, whose wells have magnetic particles to be separated time, is placed in treatment position under the magnet head 2. When it is desirable to remove the particles from the wells, the magnet head 2 is lowered into the comb of casings and these two are inserted together into the wells. The particles in the wells now adhere to the separating area of the casings 8. After this, the comb of casings and the magnet head are lifted together. When the particles are to be released, the comb of casings and the magnet head are lowered jointly into the wells, and after this the magnet head is lifted first, and then the comb of casings. Both in the steps of removing and of releasing particles, the comb of casings may perform a number of reciprocating movements (cf. WO 94/18565). In FIG. 1, the treatment station comprises a plate with relatively high wells, such a plate being usable especially for performing a separating reaction. It is, of course, possible to use also plates with lower wells, and then the casings can be accordingly shorter.

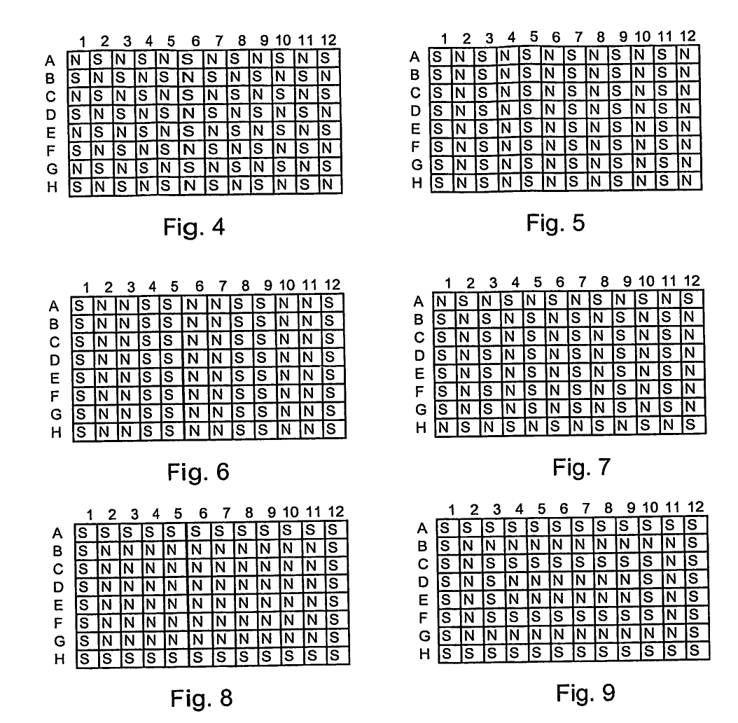

The magnets 3 of the magnet head 2 are positioned with some of the magnets turned in the opposite direction. FIGS. 4-9 illustrate such different arrays. The matrix of the magnet head comprises eight horizontal rows (A . . . H) and twelve vertical rows (1 . . . 12) corresponding to the micro plate.

In FIG. 4, every second magnet is inversely oriented.

In FIGS. 5 and 6, the magnets are disposed inversely row-wise with the magnets of the shorter row oriented in same direction.

In FIG. 7, the longer lateral rows comprise every second magnet with alternating pole directions, and in the intermediate portion the magnets are positioned with alternating pole directions row-wise, with the magnets of the shorter row oriented in same direction.

In FIG. 8, the magnets of the lateral rows are oriented in same direction and those of the remaining rows are oriented in the opposite direction.

The magnets in FIG. 9 are positioned with alternating pole directions circumferentially.

1-9. (canceled)

10. A device (2) for separating magnetic particles, comprising a plurality of substantially aligned magnets (3), wherein some of the magnets (3) are inversely oriented.

11. A separating device as defined in claim 10, in which about half of the magnets (3) are inversely oriented.

12. A separating device as defined in claim 11, in which substantially every second magnet (3) is inversely oriented.

13. A separating device as defined in claim 10, in which magnets (3) are disposed in several rows of several magnets.

14. A separating device as defined in claim 10, in which the magnets (5) are united to form one single piece (2).

15. A separating device as defined in claim 10, in which the magnets (3) are permanent magnets whose length/diameter ratio is at least about 2:1.

16. An apparatus (1) for separating magnetic particles, comprising a vertically movable separating device (2) including several substantially aligned magnets (3), wherein some of the magnets (3) are inversely oriented.

17. An apparatus as defined in claim 16, comprising a well-like casing (8) for insertion of each magnet (3).

18. An apparatus as defined in claim 17, in which the casings (8) are united to form one single piece (7).
